(19) United States
(12) Patent Application Publication
(10) Pub. No.: US 2025/0184928 A1
(43) Pub. Date: Jun. 5, 2025

(54) PREEMPTION IN WLAN

(71) Applicant: Sony Group Corporation, Tokyo (JP)

(72) Inventor: Yusuke TANAKA, Tokyo (JP)

(73) Assignee: Sony Group Corporation, Tokyo (JP)

(21) Appl. No.: 18/842,418

(22) PCT Filed: May 1, 2023
(86) PCT No.: PCT/JP2023/017045

§ 371 Date: Aug. 29, 2024

(30) Foreign Application Priority Data
Jun. 10, 2022 (JP) 2022-094437

(51) Int. Cl. H04W 56/00; H04W 8/22; H04W 84/12

(52) U.S. Cl. CPC H04W 56/001; H04W 8/22; H04W 84/12

(57) ABSTRACT

A wireless communication device including circuitry configured to control transmitting a first signal; determining, during transmission of the first signal, that a second signal is to be transmitted; terminating transmission of the first signal; transmitting a second signal after terminating transmission of the first signal, wherein the second signal includes first information indicating that transmission of the first signal has been terminated.

### TECHNICAL FIELD

The present disclosure relates to a wireless communication device and a communication method.

### BACKGROUND ART

Use cases such as Factory Automation and the spread of online games in portable devices that handle data requiring a delay amount (for example, 1 ms to 0.1 ms or less) equal to or less than a certain value are emerging.

On the other hand, since a wireless local area network (LAN), which is wireless communication using an unlicensed band, is independent distributed communication, individual communication spontaneously occurs. Therefore, even in communication that needs to be suppressed to a certain delay amount, there are cases where communication cannot be performed due to another communication that already exists and the delay amount is exceeded.

Here, preemption is known as a technology of performing different transmission by overwriting or terminating the other communication already existing. For example, in a cellular system, a technique is known in which a communication device monitors a preemption instruction to implement preemption.

### CITATION LIST

### Patent Literature

PTL 1: Japanese Laid-open Patent Publication No. 2022-502938.

### SUMMARY OF INVENTION

### Technical Problem

However, the above-described preemption technology is intended to be applied to a cellular system, and it cannot be said that application to a wireless LAN has been sufficiently studied.

In a cellular system, in principle, all communications are scheduled, and data transmission and response signal transmission are performed at predetermined timings (slots). In addition, transmission by preemption is performed in a slot in which data transmission is originally scheduled.

On the other hand, since the wireless LAN is independent distributed communication as described above, scheduling is not performed as in the cellular system. Therefore, transmission by preemption may overlap with another communication (for example, a response signal to the original data transmission, or the like), and communication quality of transmission by preemption may deteriorate.

Therefore, the present disclosure provides a mechanism capable of implementing preemption in the wireless LAN.

Note that the above problem or object is merely one of a plurality of problems or objects that can be solved or achieved by a plurality of embodiments disclosed in the present specification.

### Solution to Problem

A wireless communication device of the present disclosure includes circuitry configured to control transmitting a first signal; determining, during transmission of the first signal, that a second signal is to be transmitted; terminating transmission of the first signal; transmitting a second signal after terminating transmission of the first signal, wherein the second signal includes first information indicating that transmission of the first signal has been terminated.

### BRIEF DESCRIPTION OF DRAWINGS

FIG. 1 is a diagram illustrating a configuration example of a wireless communication system according to an embodiment of the present disclosure.

FIG. 2 is a block diagram illustrating a configuration example of a wireless communication device according to the embodiment of the present disclosure.

FIG. 3 is a diagram illustrating an example of a frame sequence implemented in the wireless communication system according to the embodiment of the present disclosure.

FIG. 4 is a diagram illustrating an example of a first response signal recovery sequence according to the embodiment of the present disclosure.

FIG. 5 is a diagram illustrating an example of a second response signal recovery sequence according to the embodiment of the present disclosure.

FIG. 6 is a diagram illustrating an example of a third response signal recovery sequence according to the embodiment of the present disclosure.

FIG. 7 is a diagram illustrating an example of a fourth response signal recovery sequence according to the embodiment of the present disclosure.

FIG. 8 is a diagram illustrating another example of the frame sequence implemented in the wireless communication system according to the embodiment of the present disclosure.

FIG. 9 is a diagram illustrating an example of frame formats of first and second signals according to the embodiment of the present disclosure.

FIG. 10 is a diagram illustrating an example of a format used by additional information according to the embodiment of the present disclosure.

FIG. 11 is a table illustrating an example of A-MPDU contents in a first signal according to the embodiment of the present disclosure.

FIG. 12 is a flowchart illustrating an example of a flow of first communication processing according to the embodiment of the present disclosure.

FIG. 13 is a flowchart illustrating an example of a flow of second communication processing according to the embodiment of the present disclosure.

### DESCRIPTION OF EMBODIMENTS

Hereinafter, embodiments of the present disclosure will be described in detail with reference to the accompanying drawings. Note that, in the present specification and the drawings, components having substantially the same functional configuration are denoted by the same reference numerals and the duplicate description is omitted.

In addition, in the present specification and the drawings, a plurality of components having substantially the same or similar functional configurations may be distinguished by adding different numbers or letters after the same reference numerals. However, in a case where it is not necessary to particularly distinguish each of the plurality of components having substantially the same or similar functional configurations, only the same reference numeral is attached. For example, when it is not necessary to particularly distinguish STAs 200A and 200B, the STAs are simply referred to as the STA 200.

One or a plurality of embodiments (examples and modifications) described below can each be implemented independently. On the other hand, at least some of the plurality of embodiments described below may be appropriately combined with at least some of other embodiments. The plurality of embodiments can include novel features different from each other. Therefore, the plurality of embodiments can contribute to solving different objects or problems from each other and can exhibit different effects from each other.

### 1. Introduction

As described above, preemption is known as a technology of performing different transmission by overwriting or terminating another communication already existing.

Normally, when data is received in a wireless LAN, an Ack signal is transmitted immediately after that (after short inter frame space (SIFS)).

However, when the preemption technology is applied to the wireless LAN, transmission of the Ack signal overlaps with different transmission started by preemption, and a signal to interference plus noise ratio (SINR) may be reduced. As a result, in addition to a decrease in system throughput, there is a possibility that retransmission is required and a delay amount is exceeded.

As described above, in a cellular system, in principle, all communications are scheduled. Therefore, a response signal such as the Ack signal does not overlap with the transmission by preemption, and the operation for such a problem is not considered.

Therefore, during transmission of a first signal, when the transmission of the first signal is terminated (preempted) and a second signal is transmitted, a first wireless communication device according to an embodiment of the present disclosure transmits the second signal including first information indicating that the first signal is terminated in the second signal.

Upon receiving information indicating that the transmission of the first signal is terminated, a second wireless communication device determines whether or not to transmit at least one of a first response signal to the first signal and a second response signal to the second signal according to a response signal transmission method. The response signal transmission method is, for example, a first response signal transmission method.

For example, it is assumed that the second wireless communication device is a destination of the first signal. That is, it is assumed that the second wireless communication device is a preempted device. In this case, it is assumed that the second wireless communication device receives the information indicating that the transmission of the first signal is terminated.

At this time, the second wireless communication device determines to transmit the first response signal to the first signal according to the response signal transmission method so as not to overlap with transmission by preemption, that is, transmission of the second signal.

As a result, the second wireless communication device can detect that preemption is performed on the first signal, and can suppress transmission of the first response signal at normal timing. In addition, the second wireless communication device can transmit the first response signal according to the response signal transmission method.

For example, it is assumed that the second wireless communication device is a destination of the second signal. In this case, it is assumed that the second wireless communication device receives the information indicating that the transmission of the first signal is terminated.

At this time, the second wireless communication device determines whether or not to transmit the second response signal to the second signal according to the response signal transmission method. For example, when the response signal transmission method is a method of transmitting the first response signal at the same timing as the second response signal, the second wireless communication device determines to transmit the second response signal according to the response signal transmission method.

Note that the first wireless communication device may notify the second wireless communication device that preemption is permitted in a normal signal (for example, a first signal) or a response signal transmission method when preemption is performed.

As described above, the first wireless communication device and the second wireless communication device according to the embodiment of the present disclosure can further prevent the response signals from overlapping with the transmission (for example, transmission of a second signal) started by preemption.

In addition, the first wireless communication device and the second wireless communication device can further suppress a decrease in the system throughput due to a decrease in the SINR due to overlapping of the response signals and an excess in the requested delay amount due to retransmission.

In addition, this makes it possible to implement the preemption technology in the wireless LAN. Therefore, communication with a delay amount equal to or less than a certain amount can be implemented in the wireless LAN.

Hereinafter, an example of a wireless communication system including the first wireless communication device and the second wireless communication device will be described.

### 2. Wireless Communication System

### <2.1. Configuration Example of Wireless Communication System>

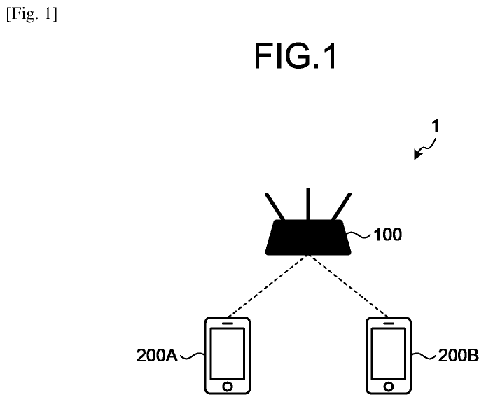

FIG. 1 is a diagram illustrating a configuration example of a wireless communication system 1 according to the embodiment of the present disclosure. The wireless communication system 1 illustrated in FIG. 1 includes an access point (AP) 100 and a station (STA) 200.

The AP 100 is, for example, a wireless communication device corresponding to a base station. The STA 200 is a wireless communication device corresponding to a terminal device. The AP 100 performs wireless LAN communication with the STA 200. A broken line illustrated in FIG. 1 illustrates an example of a connection relationship between the AP 100 and the STAs 200A and 200B. The STAs 200A and 200B communicate with the connection destination AP 100. Furthermore, communication may be performed between the STAs 200A and 200B.

FIG. 1 illustrates a case where the number of STAs 200 is two (STAs 200A and 200B), but the number of STAs 200 is not limited to two. The number of STAs 200 may be 3 or more.

The AP 100 and the STAs 200A and 200B function as either the first wireless communication device or the second wireless communication device described above. Note that, in the following description, in order to simplify the description, it is assumed that the AP 100 is the first wireless communication device and the STAs 200A and 200B are the second wireless communication devices, but the first and second wireless communication devices are not limited thereto. For example, the STA 200A may be the first wireless communication device, and the STA 200B may be the first wireless communication device. Furthermore, the AP 100 may be the second wireless communication device.

### <2.2. Configuration Example of Wireless Communication Device>

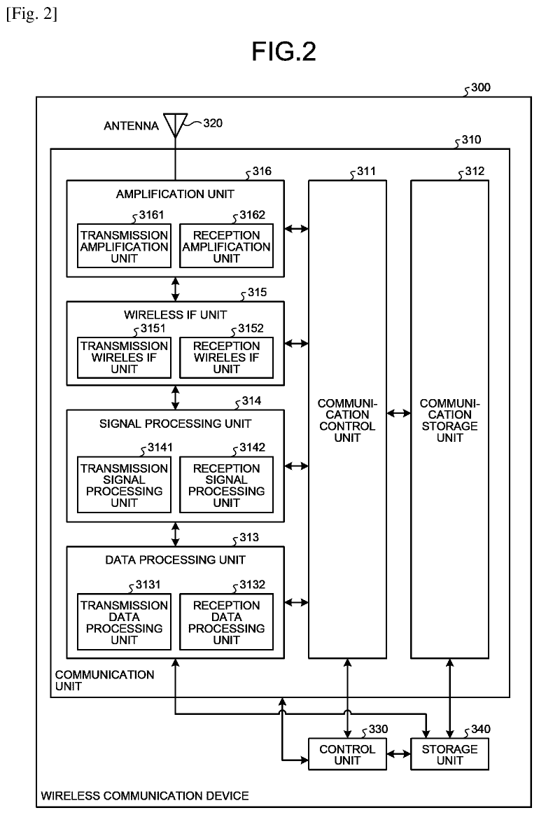

FIG. 2 is a block diagram illustrating a configuration example of a wireless communication device 300 according to the embodiment of the present disclosure. The wireless communication device 300 illustrated in FIG. 2 operates as the AP 100 or the STA 200 illustrated in FIG. 1.

The wireless communication device 300 includes a communication unit 310, an antenna 320, a control unit 330, and a storage unit 340.

The communication unit 310 communicates with, for example, another wireless communication device 300 (not illustrated). The communication unit 310 includes a communication control unit 311, a communication storage unit 312, a data processing unit 313, a signal processing unit 314, a wireless interface (IF) unit 315, and an amplification unit 316.

The communication control unit 311 controls operation of each unit of the communication unit 310 and information transmission between the units. Furthermore, the communication control unit 311 performs control for transferring control information and management information to be notified to the other wireless communication device 300 to the data processing unit 313.

In particular, in the present embodiment, in a case where the wireless communication device 300 functions as the first wireless communication device (that is, the AP 100), the communication control unit 311 controls each unit to transmit a signal including at least one of the following.
Information indicating that preemption is permitted
Information indicating a method of transmitting an Ack signal (an example of response signal) when preemption is performed
Information about being transmitted by preemption

Furthermore, the communication control unit 311 may control each unit to transmit a signal including information indicating that the signal is terminated by preemption.

Furthermore, in a case where the wireless communication device 300 functions as the second wireless communication device (that is, the STA 200), the communication control unit 311 controls each unit to operate on the basis of the method of transmitting the Ack signal notified when preemption is performed.

The communication storage unit 312 stores information used by the communication control unit 311. In addition, the communication storage unit 312 stores data to be transmitted and received data. Furthermore, the communication storage unit 312 may store IQ likelihood information of a received signal before demodulation in the signal processing unit 314 and bit stream information before decoding in the signal processing unit 314.

At the time of transmission, the data processing unit 313 performs sequence management of data stored in the communication storage unit 312, information (for example, control information and management information) received from the communication control unit 311, and the like. The data processing unit 313 performs encryption processing and the like to generate a data unit. The data processing unit 313 performs a channel access operation based on carrier sensing. The data processing unit 313 performs addition of a media access control (MAC) header and addition of an error detection code to data to be transmitted, concatenation processing on a plurality of data units described above, and the like.

At the time of reception, the data processing unit 313 performs decoupling processing, analysis and error detection on the MAC header of the received data unit, a retransmission request operation, decoding processing on the data unit, reorder processing, and the like.

The signal processing unit 314 includes a transmission signal processing unit 3141 and a reception signal processing unit 3142. The transmission signal processing unit 3141 performs encoding, interleaving, modulation, and the like on the data unit, adds a physical header to generates a symbol stream.

The reception signal processing unit 3142 analyzes the physical header, performs demodulation, deinterleaving, decoding, and the like on the symbol stream and generates a data unit. Furthermore, the reception signal processing unit 3142 performs complex channel characteristic estimation and spatial separation processing as necessary.

The wireless IF unit 315 includes a transmission wireless interface (IF) unit 3151 and a reception wireless interface (IF) unit 3152. The transmission wireless IF unit 3151 performs digital-analog signal conversion, filtering, up-conversion, phase control, and the like on the symbol stream to generate a transmission signal.

The reception wireless IF unit 3152 performs down-conversion, filtering, analog-digital signal conversion, and the like on the reception signal to generate a symbol stream.

The amplification unit 316 includes a transmission amplification unit 3161 and a reception amplification unit 3162. The transmission amplification unit 3161 amplifies the signal input from the transmission wireless IF unit 3151. The signal amplified by the transmission amplification unit 3161 is transmitted via the antenna 320. The reception amplification unit 3162 amplifies the signal input from the antenna 320.

A part of the amplification unit 316 may be a component outside the communication unit 310. Further, a part of the amplification unit 316 may be included in the wireless IF unit 315.

The control unit 330 controls the communication unit 310 and the communication control unit 311. Furthermore, the control unit 330 may perform some operations of the communication control unit 311 instead. Furthermore, the communication control unit 311 and the control unit 330 may be configured as one block.

The storage unit 340 stores information used by the control unit 330 and the communication unit 310. Furthermore, the storage unit 340 may perform some operations of the communication storage unit 312 instead. The storage unit 340 and the communication storage unit 312 may be configured as one block.

When the wireless IF unit 315, the amplification unit 316, and the antenna 320 form one set, two or more sets may be included in the wireless communication device 300. When the data processing unit 313 and the signal processing unit 314 form one set, two or more sets may be connected to one wireless IF unit 315.

The communication unit 310 or a component thereof may receive signals of a plurality of communication systems. In this case, a plurality of communication units 310 or components thereof corresponding to a plurality of communication systems may be included in the wireless communication device 300.

The communication unit 310 can be implemented by one or more large scale integration (LSI).

Note that the configuration of the communication unit 310 or the wireless communication device 300 illustrated in FIG. 2 is an example, and the configuration of the communication unit 310 or the wireless communication device 300 is not limited thereto. Furthermore, the configuration of the communication unit 310 or the wireless communication device 300 can be flexibly modified according to specifications and operations.

### 3. Preemption Operation

Next, an example of a preemption operation executed in the wireless communication system 1 according to the embodiment of the present disclosure will be described.

Here, it is assumed that, while the AP 100 functioning as the first wireless communication device is performing transmission to the STA 200A functioning as the second wireless communication device, the transmission is terminated by preemption, and transmission to the STA 200B functioning as the second wireless communication device is performed.

That is, while the AP 100 is performing downlink transmission to the STA 200A, the transmission is terminated by preemption, and downlink transmission to the STA 200B is performed.

However, this is an example, and other combinations are also applicable. For example, the STA 200A may function as the first communication device, and the AP 100 and the STA 200B may function as the second communication device. As another example of the combination, there is an example in which while the STA 200A is performing uplink transmission to the AP 100, the transmission is terminated by preemption, and peer-to-peer transmission to the STA 200B is performed.

Note that, hereinafter, the second wireless communication device (for example, the STA 200A) to be preempted may be referred to as a 2-1 wireless communication device, and the second wireless communication device (for example, the STA 200B) to receive a signal by preemption may be referred to as a 2-2 wireless communication device for distinction.

### <3.1. Example of Sequence>

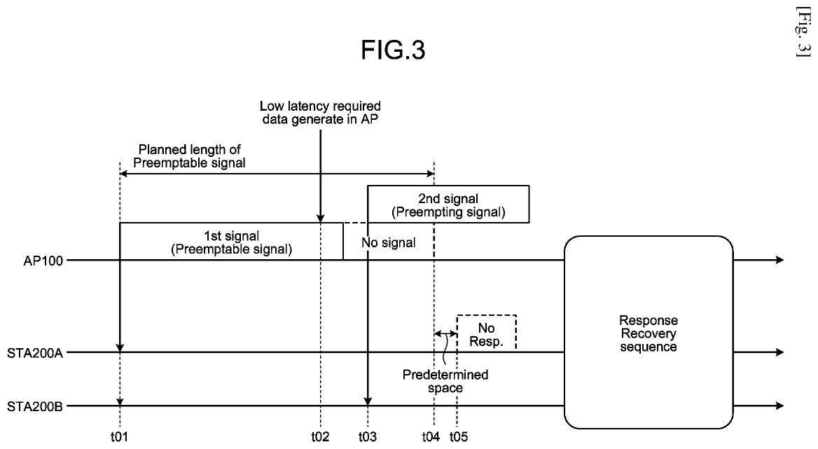

FIG. 3 is a diagram illustrating an example of a frame sequence implemented in the wireless communication system 1 according to the embodiment of the present disclosure.

Before the frame sequence illustrated in FIG. 3, the AP 100 and the STAs 200A and 200B may perform a capability check. In this capability check, the AP 100 and the STAs 200A and 200B check, for example, whether or not the AP 100 and the STAs 200A and 200B support the following functions.
Function of terminating transmission of a signal being transmitted and starting transmission of another signal (preemption)
Function related to transmission of a response signal when preemption is performed

Hereinafter, a description will be given on the assumption that the AP 100 and the STAs 200A and 200B confirm that the AP 100 and the STAs 200A and 200B support the above-described functions.

As illustrated in FIG. 3, at time t01, the AP 100 transmits a first signal (preemptable signal) allowing termination by preemption to the STA 200A.

The first signal includes first length information (Planned length of Preemptable signal) related to the scheduled length of the first signal at the transmission start time point (time t01). In addition, the first signal may include allowance information (an example of second information) indicating that there is a possibility that transmission is terminated halfway by preemption (termination is permitted).

Next, the STA 200A starts receiving the first signal. The STA 200A calculates a reception completion timing (time t04) of the first signal from the first length information included in the first signal. The STA 200A calculates a timing (time t05) after a predetermined time interval (predetermined space) from the reception completion timing (time t04) as a response timing for transmitting a response signal to the first signal.

The time interval may be a time interval determined by a law or may be a short inter frame space (SIFS) defined by IEEE 802.11.

Next, the STA 200B starts receiving the first signal. Normally, when it is determined that the destination of the first signal is the other device (here, the STA 200A) and is not the own device, the STA 200B stops demodulation or transitions to a power saving state (doze state).

However, in a case where the first signal includes the above-described allowance information (information indicating that the signal allows preemption), the STA 200B may perform control so as not to stop demodulation or enter the power saving state (doze state) even when it is determined that the first signal is not addressed to the own device.

Here, it is assumed that low latency required data that needs to be transmitted within a certain delay time is generated in the AP 100 at time t02 when the first signal is being transmitted.

At this time, the AP 100 calculates whether or not the transmission of the low latency required data is completed within a certain delay time when the low latency required data is transmitted after transmitting the first signal and receiving the assumed response signal. This calculation is performed using the information amount of the low latency required data and communication parameters (modulation and coding scheme, frequency bandwidth, number of spatial streams, signal format, and the like) used for transmission.

When it is calculated that the transmission of the low latency required data is completed within a certain delay time, the AP 100 transmits the low latency required data according to a normal transmission procedure after transmitting the first signal and receiving the assumed response signal. When it is calculated that the transmission of the low latency required data is not completed within a certain delay time, the AP 100 determines to perform preemption. Here, it is assumed that the AP 100 determines to perform preemption.

Upon determining to perform preemption, the AP 100 performs an operation of terminating transmission of the first signal being transmitted. This operation may be performed without special processing or may be performed after transmission to a boundary of a coded block.

Alternatively, this operation may be performed after transmission to the boundary of the information units concatenated and stored in the first signal. The information unit may be an MPDU in an Aggregation MAC Protocol Data Unit (A-MPDU) defined by IEEE 802.11.

Further, this operation may be performed after the first signal to which any one of pieces of the following information is added at the end is transmitted. The information added to the end of the first signal is also described as additional information.
Information indicating that termination is performed by preemption
Response information related to transmission (transmission method) of a response signal
Information (end of file (EOF)=1) indicating the last information unit concatenated and stored in the first signal
Information for length adjustment (padding)

Note that the response signal may be any of Ack, Block Ack, and Multi-STA Block Ack defined in IEEE 802.11.

Upon performing the operation of terminating the transmission of the first signal, the AP 100 transmits, at time t03, a second signal (preempting signal) to be transmitted to the STA 200B after another transmission (here, transmission of the first signal) is terminated by preemption. The transmission is started within a predetermined time interval after the first signal is terminated. The predetermined time interval may be a time interval determined by a law or may be an SIFS defined by IEEE 802.11.

The second signal includes, for example, second length information related to the length of the second signal, and preemption information (an example of the first information) indicating that transmission is performed after another transmission is terminated by preemption.

Next, the STA 200A starts receiving the second signal. The STA 200A detects that the received first signal is terminated by preemption from the preemption information included in the second signal.

Furthermore, the STA 200A may calculate a transmission completion timing (hereinafter, also described as a second transmission completion timing) of the second signal from the second length information included in the second signal. Furthermore, the STA 200A may calculate a transmission completion timing (hereinafter, also described as a second response transmission completion timing) of a response signal (hereinafter, also described as the second response signal) to the second signal transmitted from the STA 200B after a predetermined time interval (predetermined space) from the calculated second transmission completion timing. The time interval may be a time interval determined by a law or may be an SIFS defined by IEEE 802.11.

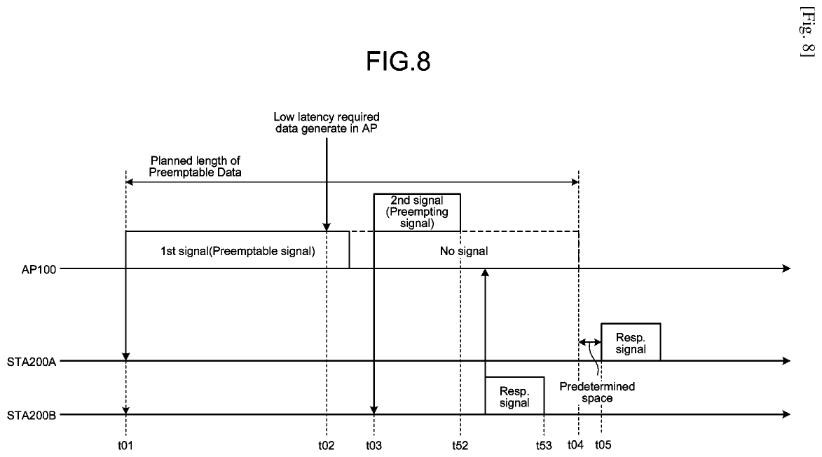

For example, it is assumed that the second response transmission completion timing is before the timing (time t05) of transmitting the response signal (hereinafter, also described as the first response signal) calculated at the time of receiving the first signal. In this case, the STA 200A transmits the first response signal as it is at the timing (time t05) of transmitting the first response signal. Another example of this frame sequence will be described later with reference to FIG. 8.

On the other hand, when the second response transmission completion timing is later than the timing of transmitting the response signal calculated at the time of receiving the first signal, the STA 200A performs control not to transmit the first response signal at the timing of transmitting the first response signal (time t05).

Furthermore, when the response information (an example of the third information) related to transmission of the response signal is added to the first signal, the STA 200A performs a response signal recovery sequence (a response recovery sequence) according to the response information. That is, when the second response transmission completion timing is later than the timing (time t05) of transmitting the first response signal calculated at the time of receiving the first signal, the STA 200A determines to perform the response signal recovery sequence according to the response information.

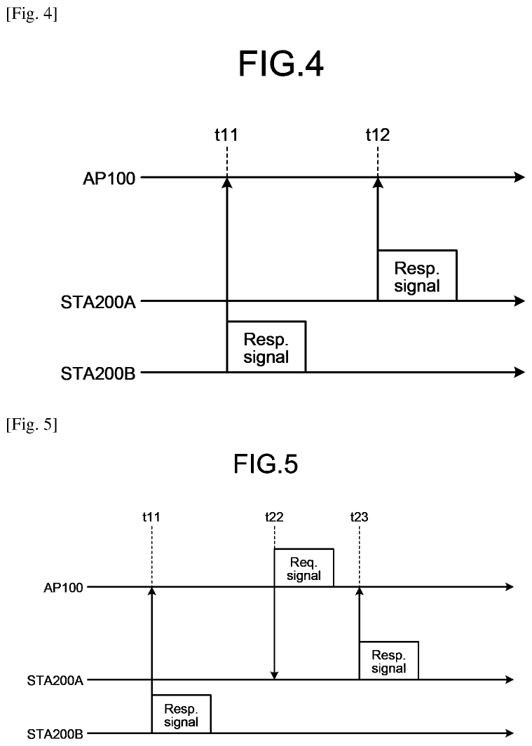

Note that information corresponding to the response information may be exchanged between the AP 100 and the STA 200A in the capability check. This response signal recovery sequence will be described later with reference to FIGS. 4 to 7. Depending on an example of the response signal recovery sequence (for example, FIG. 7), the information corresponding to the response information may be exchanged between the AP 100 and the STA 200B.

Furthermore, the STA 200A may demodulate, deinterleave, and decode information included in the first signal received halfway to generate a data unit (MPDU), may store data subjected to decoding, or may store IQ likelihood information of a demodulated signal.

Next, the STA 200B starts receiving the second signal. After completion of the reception of the second signal, the STA 200B performs a response signal recovery sequence according to the response information. Note that, except for some examples (for example, FIG. 7), the STA 200B transmits the second response signal as the response signal recovery sequence as usual. Alternatively, the STA 200B may transmit the second response signal as usual separately from the response signal recovery sequence, that is, without executing the response signal recovery sequence.

After transmitting the second signal, the AP 100 performs a response signal recovery sequence. As a result, the AP 100 receives the response signal to the first signal from the STA 200A and receives the response signal to the second signal from the STA 200B.

### Response Signal Recovery Sequence

Hereinafter, an example of a response signal recovery sequence executed in the wireless communication system 1 after transmission and reception of the second signal will be described. The STA 200A transmits the first response signal according to the response signal transmission method in the response signal recovery sequence. In the present embodiment, examples of first to fourth response signal recovery sequences with different response signal transmission methods will be described.

### First Response Signal Recovery Sequence

FIG. 4 is a diagram illustrating an example of a first response signal recovery sequence according to the embodiment of the present disclosure.

First, at time t11, the STA 200B transmits a second response signal to the second signal to the AP 100. The second response signal is a signal transmitted from the STA 200B to the AP 100 as usual, that is, after a predetermined time interval (predetermined space) from the reception completion timing of the second signal. The time interval may be a time interval determined by a law or may be an SIFS defined by IEEE 802.11.

Next, after acquiring the transmission right by performing carrier sensing, the STA 200A transmits a first response signal to the first signal to the AP 100 at time t12. The first response signal includes information related to success or failure of decoding the information included in the first signal received halfway. The first response signal may be Ack, Block Ack, or Multi-STA Block Ack defined in IEEE 802.11.

As described above, in the first response signal recovery sequence, the STA 200B transmits the second response signal by the normal transmission method, and the STA 200A transmits the first response signal by the transmission method (hereinafter, also described as a first transmission method) in which transmission is performed after the transmission right is acquired.

### Second Response Signal Recovery Sequence

FIG. 5 is a diagram illustrating an example of a second response signal recovery sequence according to the embodiment of the present disclosure. Since the transmission of the second response signal by the STA 200B is the same as that in FIG. 4, the description thereof will be omitted.

After acquiring the transmission right by performing carrier sensing, the AP 100 transmits a request signal for requesting a first response signal to the first signal to the STA 200A at time t22. The request signal may include information related to the communication parameters (modulation and coding scheme, frequency bandwidth, number of spatial streams, signal format, and the like) used for transmission of the first response signal.

Upon receiving the request signal, the STA 200A transmits a first response signal to the first signal to the AP 100 at time t23 after a predetermined time interval. The time interval may be a time interval determined by a law or may be an SIFS defined by IEEE 802.11. The first response signal is similar to the first response signal illustrated in FIG. 4.

As described above, in the second response signal recovery sequence, the STA 200B transmits the second response signal by the normal transmission method, and the STA 200A transmits the first response signal by the transmission method (hereinafter, also described as the second transmission method) in which transmission is performed in response to a request from the AP 100.

### Third Response Signal Recovery Sequence

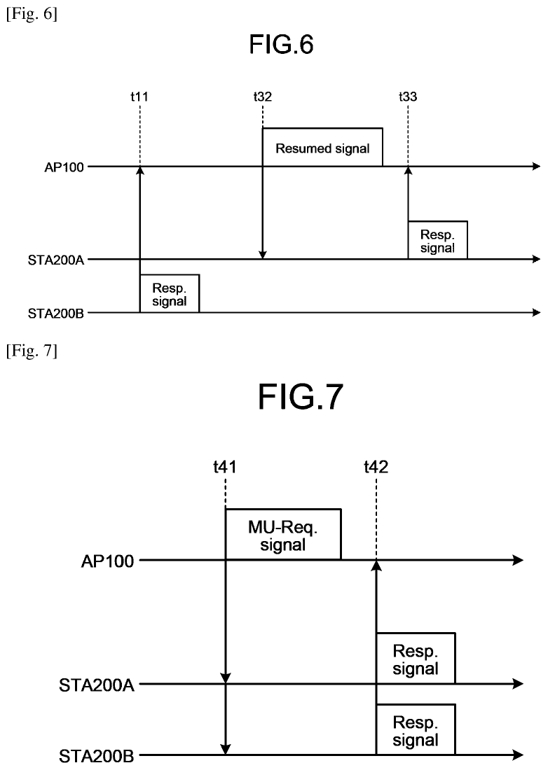

FIG. 6 is a diagram illustrating an example of a third response signal recovery sequence according to the embodiment of the present disclosure. Since the transmission of the second response signal by the STA 200B is the same as that in FIG. 4, the description thereof will be omitted.

After acquiring the transmission right by performing carrier sensing, the AP 100 transmits a resumed signal that is a continuation of the first signal terminated by preemption to the STA 200A at time t32.

The resumed signal includes a data unit (MPDU) that is scheduled to be transmitted at the start of transmission of the first signal and that is not transmitted by preemption. Furthermore, the resumed signal may include a new data unit. Furthermore, the resumed signal may include a coded block that is a continuation of the transmitted coded block.

Upon receiving the resumed signal, the STA 200A transmits a first response signal to the first signal to the AP 100 at time t33 after a predetermined time interval. The time interval may be a time interval determined by a law or may be a short inter frame space (SIFS) defined by IEEE 802.11.

The first response signal includes, for example, information related to success or failure of decoding the information included in the first signal received halfway, and information related to success or failure of decoding the information included in the resumed signal that is a continuation of the first signal.

Furthermore, the STA 200A may perform error detection by combining a coded block included in the first signal and a coded block included in a resumed signal that is a continuation of the first signal and may include success or failure of the error detection in the first response signal.

Furthermore, the STA 200A may combine the IQ likelihood information of the demodulated first signal and the IQ likelihood information of the resumed signal that is a continuation of the demodulated first signal, and include information related to success or failure in decoding the combined information in the first response signal. The first response signal may be Ack, Block Ack, or Multi-STA Block Ack defined in IEEE 802.11.

As described above, in the third response signal recovery sequence, the STA 200B transmits the second response signal by the normal transmission method, and the STA 200A transmits the first response signal by the transmission method (hereinafter, also described as a third transmission method) in which transmission is performed in response to a resumed from the AP 100.

### Fourth Response Signal Recovery Sequence

FIG. 7 is a diagram illustrating an example of a fourth response signal recovery sequence according to the embodiment of the present disclosure. Here, the STA 200B does not normally transmit the second response signal but transmits the second response signal according to the response signal transmission method.

First, the AP 100 transmits, at time t41, a request signal (MU (Multi-User)-Request signal) for requesting the STAs 200A and 200B to transmit a response signal. The request signal may be transmitted to a broadcast destination. The request signal may be a Trigger frame defined by IEEE 802.11 or a MU-BAR variant of the Trigger frame.

The request signal may include information related to identifiers indicating the STAs 200A and 200B. The identifier may be a MAC address of each of the STAs 200A and 200B, or may be an association ID (AID) defined by IEEE 802.11.

The request signal includes information related to the communication parameters (modulation and coding scheme, frequency bandwidth, number of spatial streams, signal format, and the like) used for transmission of a response signal by each of the STAs 200A and 200B (for example, first and second response signals).

Upon receiving the request signal, the STAs 200A and 200B multiplex the request signal using the information related to the communication parameters included in the request signal, and transmit the first and second response signals to the AP 100 at time 142. The first and second response signals are similar to the first and second response signals illustrated in FIG. 4.

The multiplexing here may be Orthogonal Frequency Division Multiple Access (OFDMA) or Multi User Multiple Input Multiple Output (MU-MIMO). The first and second response signals may be transmitted using the HE TB PPDU format or the EHT TB PPDU format defined by IEEE 802.11.

As described above, in the fourth response signal recovery sequence, the STAs 200A and 200B transmit the first and second response signals by the transmission method (hereinafter, also described as a fourth transmission method) in which multiplexing and transmission are performed in response to a request signal from the AP 100.

Note that, in a case where the AP 100 and the STA 200A support communication using a plurality of links (Multi-Link Operation), the STA 200A may transmit the first response signal on a second link different from a first link on which the first signal and the second signal are transmitted. For example, when the first response signal is transmitted by the first to third transmission methods, the STA 200A can transmit the first response signal on the second link different from the first link on which the first signal and the second signal are transmitted.

Furthermore, it is assumed that the AP 100 and the STA 200A support communication using a plurality of links capable of simultaneous transmission and reception (Simultaneous Tx Rx Multi-Link Operation). In this case, when the second link different from the first link is used, the transmission of the first response signal may not be performed after the second response signal transmitted by the STA 200B. For example, the STA 200A may transmit the first response signal in parallel with transmission of the second signal or transmission of the second response signal.

### <3.2. Another Example of Sequence>

FIG. 8 is a diagram illustrating another example of the frame sequence implemented in the wireless communication system 1 according to the embodiment of the present disclosure. The sequence until the transmission of the second signal at time t02 is the same as that in FIG. 3, and thus the description thereof will be omitted.

As described above, the STA 200A can calculate the second transmission completion timing (time t52 in FIG. 8) at which the transmission of the second signal is completed and the second response transmission completion timing (time t53 in FIG. 8) at which the transmission of the second response signal to the second signal is completed.

Here, as illustrated in FIG. 8, it is assumed that the second response transmission completion timing (time t53) is before the timing (time t05) of transmitting the first response signal calculated at the time of receiving the first signal. In this case, the STA 200A transmits the first response signal at the timing (time t05) of transmitting the first response signal calculated at the time of receiving the first signal.

As described above, in a case where the second response transmission completion timing (time t53) is before the timing (time t05) of transmitting the first response signal calculated at the time of receiving the first signal, the STA 200A determines not to perform the response signal recovery sequence according to the response information. That is, the STA 200A determines not to transmit the first response signal according to the first to fourth transmission methods.

### 4. Frame Format

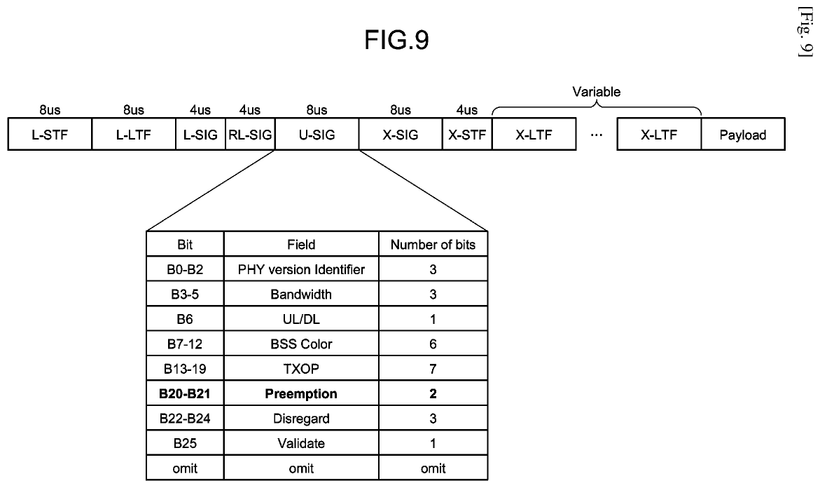

FIG. 9 is a diagram illustrating an example of frame formats of first and second signals according to the embodiment of the present disclosure. This format corresponds to the PHY format in IEEE 802.11. This format includes L-STF, L-LTF, L-SIG, RL-SIG, U-SIG, X-SIG, X-STF, X-LTF, and Payload.

The L-STF and the L-LTF are known signal sequences for reception terminals (for example, STAs 200A and 200B) to perform frequency offset estimation, timing synchronization, reception gain adjustment, and the like. The L-SIG and the RL-SIG include the length of the present signal and information (for example, first and second length information) on the modulation and coding scheme after the present field.

The U-SIG includes information related to a version of the format and information related to preemption. The X-SIG includes information related to various communication parameters of the signal. The information related to preemption may be included in the X-SIG.

The X-STF and the X-LTF are known signal sequences for the reception terminal to perform frequency offset estimation, timing synchronization, reception gain adjustment, and the like. The payload includes an information body of the signal.

The information related to preemption includes preemption information indicating that transmission is performed after another transmission is terminated by preemption. In addition, the information related to preemption may include allowance information indicating that termination by preemption is permitted. For example, the information related to preemption included in the first signal can include allowance information. Furthermore, for example, the information related to preemption included in the second signal can include preemption information.

The information related to preemption may be notified using, for example, bits allocated to the Disregard of the U-SIG. For example, 1 bit may be used to notify by setting “1” if transmission is performed after another transmission is terminated by preemption, and setting “0” otherwise.

In addition, for example, using 2 bits, the first bit may be used to notify whether or not transmission is performed after another transmission is terminated by preemption, and the second bit may be used to notify whether or not termination by preemption is permitted.

In addition, in the case of using 2 bits, some combinations may be invalidated. For example, a notification (preemption information) transmitted after another transmission is terminated by preemption and a notification (allowance information) allowing termination by preemption may not be simultaneously made.

Furthermore, in a case where a notification that allows termination by preemption is made, a notification that does not allow transmission of the present signal in parallel using spatial reuse may not be made. For example, the Spatial Reuse field defined by IEEE 802.11 may be set to PSR_AND_NON_SRG_OBSS_PD_PROHIBITED or PSR_DISALLOW.

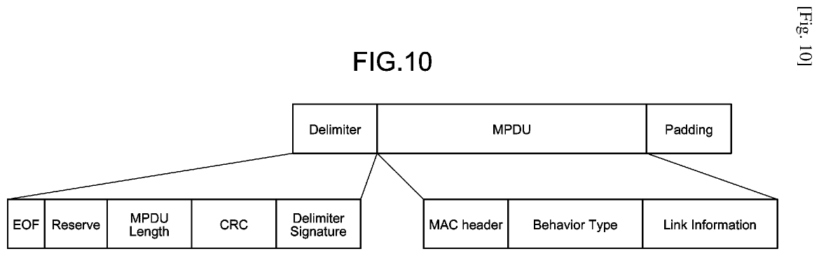

FIG. 10 is a diagram illustrating an example of a format used by additional information according to the embodiment of the present disclosure. The additional information is information added to the end of the first signal. This format is stored in the Payload of FIG. 9. As illustrated in FIG. 10, the format includes Delimiter, MPDU, and Padding.

The Delimiter is a field indicating a boundary of MPDUs to be concatenated and includes EOF, Reserve, MPDU Length, Cyclic Redundancy Check (CRC), and Delimiter Signature.

The EOF includes information indicating whether or not the MPDU following the Delimiter is the end of the MPDU to be concatenated. In this format, the EOF is set to indicate the end (EOF=1).

The Reserve is a reservation field. The MPDU Length includes information related to a length of the MPDU following the Delimiter. The CRC includes information related to error detection. The Delimiter Signature includes information for detecting the Delimiter.

The MPDU includes MAC Header, Behavior Type, and Link Information. The MAC Header includes a transmission source MAC address and a transmission destination MAC address of the MPDU, information indicating that the format is an MPDU related to preemption, and other information related to the MPDU.

The Behavior Type includes information related to transmission of a response signal. For example, information indicating any one of the response signal transmission methods illustrated in FIGS. 4 to 7 is included. The Behavior Type uses, for example, 2 bits to specify the response signal transmission methods illustrated in FIGS. 4 to 7. For example, “00” indicates the response signal transmission method (first transmission method) illustrated in FIGS. 4, and “11” indicates the response signal transmission method (fourth transmission method) illustrated in FIG. 7. The Behavior Type may be omitted when a response signal transmission method is specified in advance.

The STAs 200A and 200B receive this information and determine whether or not to transmit a response signal according to the transmission method. For example, the STA 200A receives this information, and determines whether or not to transmit the first response signal according to the transmission method according to the timing of the second response signal (see time t53 in FIG. 8) or the like. This information corresponds to, for example, the response information related to the transmission of the response signal described above.

For example, the STA 200B receives this information and determine whether or not to transmit a second response signal according to the transmission method according to the transmission method or the like. For example, when the transmission method specified by this information is any of the first to third transmission methods, the STA 200B determines not to transmit the second response signal according to the transmission method, that is, determines to transmit the second response signal as usual. On the other hand, when the transmission method specified by this information is the fourth transmission method, the STA 200B determines to transmit the second response signal according to the transmission method.

The Link Information in FIG. 10 includes information related to a link for performing the operations in FIGS. 4 to 7 when the AP 100 and the STA 100A support communication using a plurality of links (Multi-Link Operation). Note that the Link Information may be omitted when the AP 100 and the STA 100A do not support communication using a plurality of links (Multi-Link Operation).

The Behavior Type and Link Information illustrated in FIG. 10 may be included in MAC Header. For example, the Behavior Type and Link Information may be included in A-Control field of MAC Header defined by IEEE 802.11. In this case, the MPDU may use the QoS-Null including no information other than the MAC header.

The padding includes information related to length adjustment.

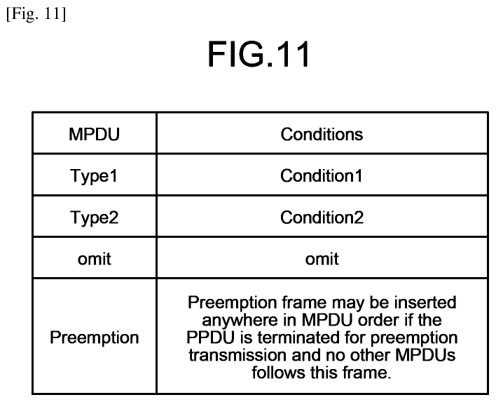

FIG. 11 is a table illustrating an example of A-MPDU contents in the first signal according to the embodiment of the present disclosure. Here, it is assumed that the first signal is a signal preempted by the second signal.

When an MPDU related to preemption (an MPDU including information related to preemption) transmitted by using this format is concatenated with another data unit (MPDU) and transmitted, the other MPDU is concatenated first, and the MPDU related to preemption is concatenated last.

For example, as illustrated in FIG. 11, MPDUs corresponding to the Type 1 type are concatenated first, MPDUs corresponding to the Type 2 type are concatenated next, and MPDUs related to Preemption are concatenated last.

However, when the first signal is terminated by preemption, the MPDUs related to preemption are interrupted and concatenated in any order on condition that no other MPDU is concatenated after the MPDU related to preemption.

### 5. Communication Processing

### <5.1. First Communication Processing>

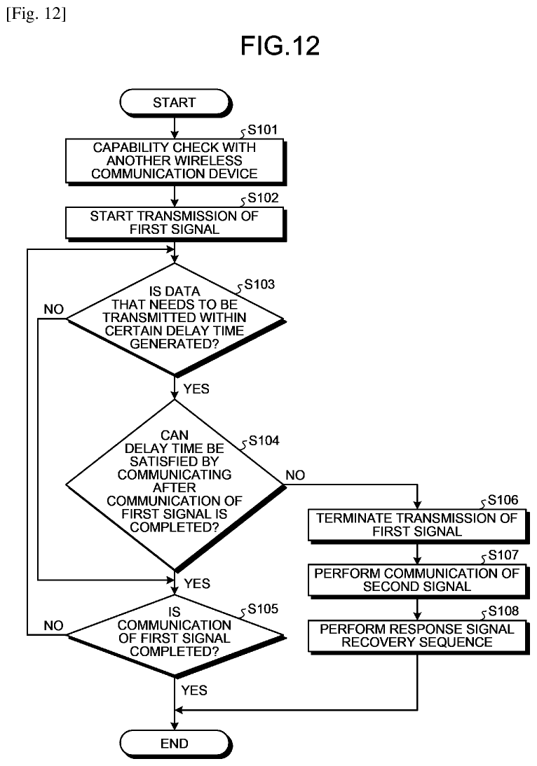

FIG. 12 is a flowchart illustrating an example of a flow of first communication processing according to the embodiment of the present disclosure. The first communication processing is executed, for example, by the first wireless communication device (for example, AP 100).

As illustrated in FIG. 12, for example, the first wireless communication device performs a capability check with another wireless communication device (for example, STAs 100A and 200B) (Step S101).

The first wireless communication device starts transmitting the first signal (Step S102). For example, when the first wireless communication device is the AP 100, the AP 100 transmits the first signal to the STA 200A.

Next, the first wireless communication device determines whether or not data (low latency required data) that needs to be transmitted within a certain delay time is generated (Step S103). When it is determined that the data is not generated (Step S103; No), the first wireless communication device proceeds to Step S105.

On the other hand, when it is determined that data that needs to be transmitted within a certain delay time is generated (Step S103; Yes), the first wireless communication device determines whether or not the delay time can be satisfied by communicating the data after the communication of the first signal is completed (Step S104).

When it is determined that the delay time can be satisfied (Step S104; Yes), the first wireless communication device determines whether or not the communication of the first signal is completed (Step S105). When it is determined that the communication of the first signal is not completed (Step S105; No), the first wireless communication device returns to Step S103 and determines whether or not the low latency required data is generated.

On the other hand, when it is determined that the communication of the first signal is completed (Step S105; Yes), the first wireless communication device ends the first communication processing. The first wireless communication device can then transmit data that needs to be transmitted within a certain delay time as a second signal.

When it is determined in Step S104 described above that the delay time is not satisfied when data that needs to be transmitted within a certain delay time is communicated after completion of communication of the first signal (Step S104; No), the first wireless communication device terminates the transmission of the first signal (Step S106).

Subsequently, the first wireless communication device uses the data that needs to be transmitted within a certain delay time as the second signal, and performs communication of the second signal (Step S107). For example, when the first wireless communication device is the AP 100, the AP 100 transmits the second signal to the STA 200B.

Thereafter, the first wireless communication device performs a response signal recovery sequence (Step S108), and ends the first communication processing. For example, the first wireless communication device performs the first to fourth response signal recovery sequences described above (see FIGS. 4 to 7).

### <5.2. Second Communication Processing>

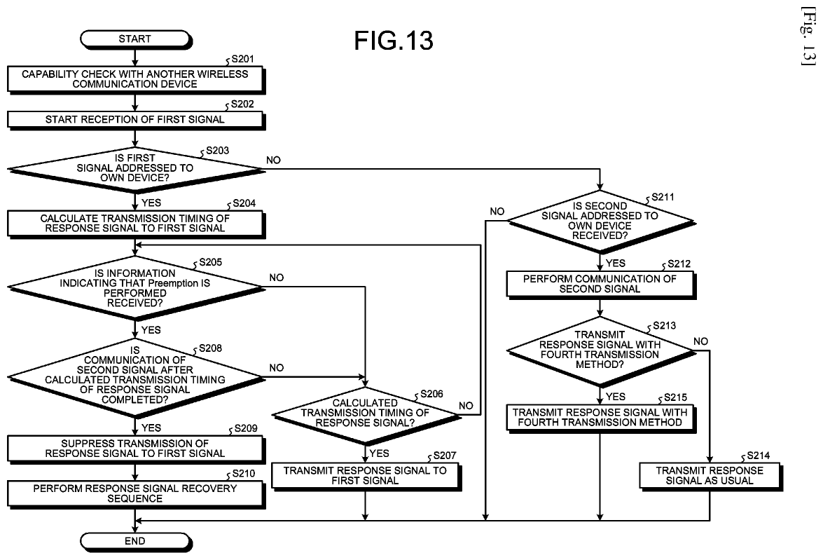

FIG. 13 is a flowchart illustrating an example of a flow of second communication processing according to the embodiment of the present disclosure. The second communication processing is executed, for example, by the second wireless communication device (for example, STAs 200A and 200B).

As illustrated in FIG. 13, for example, the second wireless communication device performs a capability check with another wireless communication device (for example, AP 100) (Step S201).

The second wireless communication device starts receiving the first signal (Step S202). The second wireless communication device determines whether or not the received first signal is addressed to the own device (Step S203). When it is determined that the first signal is not addressed to the own device (Step S203; No), the second wireless communication device performs the processing in and after Step S211 described later. For example, when the second wireless communication device is the STA 200B, the processing in and after Step S211 described later is executed.

When it is determined that the first signal is addressed to the own device (Step S203; Yes), the second wireless communication device performs the processing of Steps S204 to S210. For example, when the second wireless communication device is the STA 200A, the processing of Steps S204 to S210 is executed.

For example, when it is determined that the first signal is addressed to the own device (Step S203; Yes), the second wireless communication device calculates a transmission timing of the response signal (first response signal) to the first signal (Step S204).

Next, the second wireless communication device determines whether or not information indicating that the first signal is preempted is received (Step S205).

When it is determined that the information indicating that preemption is performed is not received (Step S205; No), the second wireless communication device determines whether or not it is the calculated transmission timing of the response signal (first response signal) (Step S206).

When it is determined that it is not the calculated transmission timing (Step S206; No), the second wireless communication device returns to Step S205 and determines whether or not the first signal is preempted.

When it is determined that it is the transmission timing of the response signal (first response signal) (Step S206; Yes), the second wireless communication device transmits the response signal (first response signal) to the first signal (Step S207), and ends the second communication processing.

When it is determined in step S205 that the information indicating that the first signal is preempted is received (Step S205; Yes), the second wireless communication device determines whether or not the communication of the second signal is completed after the calculated transmission timing of the response signal (Step S208).

When it is determined that the communication of the second signal is not completed after the calculated transmission timing, that is, when it is determined that the communication of the second signal is completed before the transmission timing of the first response signal (Step S208; No), the second wireless communication device proceeds to Step S206.

On the other hand, when it is determined that the communication of the second signal is completed after the calculated transmission timing (Step S208; Yes), the second wireless communication device suppresses transmission of the response signal (first response signal) to the first signal (Step S209).

Thereafter, the second wireless communication device performs a response signal recovery sequence (Step S210), and ends the second communication processing.

When it is determined in Step S203 described above that the first signal is not addressed to the own device (Step S203; No), the second wireless communication device determines whether or not a second signal addressed to the own device is received (Step S211).

When it is determined that the second signal is not received (Step S211; No), the second wireless communication device ends the second communication processing.

On the other hand, when it is determined that the second signal is received (Step S211; Yes), the second wireless communication device performs communication of the second signal (Step S212).

The second wireless communication device determines whether or not to transmit a response signal (second response signal) to the second signal according to the fourth transmission method (Step S213).

When it is determined that transmission is not performed according to the fourth transmission method (Step S213; No), the second wireless communication device transmits the response signal to the second signal as usual (Step S214), and ends the second communication processing.

On the other hand, when it is determined that transmission is performed according to the fourth transmission method (Step S213; Yes), the second wireless communication device transmits the response signal to the second signal according to the fourth transmission method (Step S215), and ends the second communication processing.

### 6. Other Embodiments

The above-described embodiments and application examples are examples, and various modifications and applications are possible.

For example, the control device that controls the wireless communication device 300 of the present embodiment may be implemented by a dedicated computer system or may be implemented by a general-purpose computer system.

For example, a program for executing the above-described operation is stored and distributed in a computer-readable recording medium such as an optical disk, a semiconductor memory, a magnetic tape, or a flexible disk. Then, the control device is configured to, for example, install the program in a computer and perform the above-described processing. At this time, the control device may be a device (for example, a personal computer) outside the wireless communication device 300. Furthermore, the control device may be a device (for example, the control unit 330) inside the wireless communication device 300.

In addition, the program may be stored in a disk device included in a server device on a network such as the Internet so that the program can be downloaded to a computer. In addition, the above-described functions may be implemented by cooperation of an operating system (OS) and application software. In this case, a portion other than the OS may be stored in a medium and distributed, or a portion other than the OS may be stored in a server device and downloaded to a computer.

Among the processes described in the above embodiments, all or a part of the processes described as being performed automatically can be performed manually, or all or a part of the processes described as being performed manually can be performed automatically by a known method. In addition, the processing procedure, specific name, and information including various kinds of data and parameters illustrated in the document and the drawings can be freely changed unless otherwise specified. For example, the various types of information illustrated in each drawing are not limited to the illustrated information.

In addition, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in any units according to various loads, usage conditions, and the like. Note that this configuration by distribution and integration may be performed dynamically.

In addition, the above-described embodiments can be appropriately combined in a region in which the processing contents do not contradict each other. Furthermore, the order of each Step illustrated in the sequence diagram and the flowchart of the above-described embodiment can be changed as appropriate.

Furthermore, for example, the present embodiment can be implemented as any configuration configuring a device or a system, for example, a processor as a system LSI or the like, a module using a plurality of processors or the like, a unit using a plurality of modules or the like, a set obtained by further adding other functions to a unit, or the like (that is, a configuration of a part of the device).

Note that, in the present embodiment, the system means a set of a plurality of components (devices, modules (parts), and the like), and it does not matter whether or not all the components are in the same housing. Therefore, a plurality of devices housed in separate housings and connected via a network and one device in which a plurality of modules are housed in one housing are both systems.

Furthermore, for example, the present embodiment can adopt a configuration of cloud computing in which one function is shared and processed by a plurality of devices in cooperation via a network.

### 7. Summary

Although the embodiments of the present disclosure have been described above, the technical scope of the present disclosure is not limited to the above-described embodiments as it is, and various changes can be made without departing from the gist of the present disclosure. In addition, components of different embodiments and modifications may be appropriately combined.

Furthermore, the effects of the embodiments described in the present specification are merely examples and are not limited, and other effects may be provided.

Note that the present technology can also have the following configurations.

(1)

A wireless communication device comprising:

circuitry configured to control

transmitting a first signal;

determining, during transmission of the first signal, that a second signal is to be transmitted;

terminating transmission of the first signal;

transmitting a second signal after terminating transmission of the first signal, wherein the second signal includes first information indicating that transmission of the first signal has been terminated.

(2)

The wireless communication device of (1), wherein the first signal includes second information indicating that termination is permitted during transmission.

(3)

The wireless communication device of (1) or (2), wherein the circuitry is configured to control terminating transmission of the first signal and transmitting data requiring a delay equal to or less than a predetermined delay as the second signal in a case that the data is generated during transmission of the first signal.

(4)

The wireless communication device of any of (1) to (3), wherein the first information is stored in a PHY header of the second signal.

(5)

The wireless communication device of any of (1) to (4), wherein the circuitry is configured control notifying a first wireless communication device that is a destination of the first signal of a transmission method of a response signal to the first signal.

(6)

The wireless communication device of (5), wherein the circuitry is configured to control notifying the transmission method when performing a capability check with another wireless communication device.

(7)

The wireless communication device of (5) or (6), wherein the circuitry is configured to add information indicating the transmission method to an end of the first signal and control transmitting the first signal.

(8)

The wireless communication device of any of (5) to (7), wherein the circuitry is configured to control reception of at least one of the response signal to the first signal from a first wireless communication device that is a destination of the first signal and the response signal to the second signal from a second wireless communication device that is a destination of the second signal according to the transmission method.

(9)

The wireless communication device of any of (1) to (8), wherein the circuitry is configured to calculate a delay time for completing transmission of data from the first wireless communication device.

(10)

The wireless communication device of (9), wherein the circuity is configured to determine to control transmission of the second signal including the data and control termination of transmission of the first signal in a case that the calculated delay time is less than a threshold value.

(11)

The wireless communication device of any of (1) to (10), wherein the wireless communication device is an access point (AP) that operates in compliance with IEEE 802.11.

(12)

A wireless communication device comprising:

circuitry configured to control

receiving information indicating that transmission of a first signal by a transmission device is terminated in a case that transmission of the first signal is terminated by the transmission device and a second signal is transmitted by the transmission device; and
determining whether to transmit at least one of a first response signal to the first signal and a second response signal to the second signal according to a transmission method of the first response signal to the first signal.
   (13)

The wireless communication device of (12), wherein the circuitry is configured to: calculate a transmission timing of the first response signal in a case that the first signal is addressed to the own device; and control transmission of the first response signal at the calculated transmission timing based on a length of the second signal.

(14)

The wireless communication device of (12) or (13), wherein the transmission method is notified by the transmission device.

(15)

The wireless communication device of (14), wherein the transmission method is notified when a capability check is performed with the transmission device.

(16)

The wireless communication device of (14) or (15), wherein the transmission method is notified by information stored at an end of the first signal.

(17)

The wireless communication device of any of (12) to (16), wherein the circuitry is configured to perform control to not transmit the first response signal, not stop demodulation, or not shift to a power saving state when the first signal is not addressed to the wireless communication device.

(18)

The wireless communication device of (17), wherein

the circuitry is configured to control transmission of the second response signal.
(19)

A communication method comprising:

transmitting a first signal;

determining, during transmission of the first signal, that a second signal is to be transmitted;

terminating transmission of the first signal;

transmitting a second signal after terminating transmission of the first signal, wherein

the second signal includes first information indicating that transmission of the first signal has been terminated.

(20)

A communication method comprising:

receiving information indicating that transmission of a first signal by a transmission device is terminated in a case that transmission of the first signal is terminated by the transmission device and a second signal is transmitted by the transmission device; and determining whether to transmit at least one of a first response signal to the first signal and a second response signal to the second signal according to a transmission method of the first response signal to the first signal.

### Reference Signs List

1 wireless communication system
100 AP
200 STA
300 wireless communication device
310 communication unit
320 antenna
330 control unit
340 storage unit

1. A wireless communication device comprising:
circuitry configured to control
transmitting a first signal;
determining, during transmission of the first signal, that a second signal is to be transmitted;
terminating transmission of the first signal;
transmitting a second signal after terminating transmission of the first signal, wherein
the second signal includes first information indicating that transmission of the first signal has been terminated.

2. The wireless communication device of claim 1, wherein
the first signal includes second information indicating that termination is permitted during transmission.

3. The wireless communication device of claim 1, wherein
the circuitry is configured to control terminating transmission of the first signal and transmitting data requiring a delay equal to or less than a predetermined delay as the second signal in a case that the data is generated during transmission of the first signal.

4. The wireless communication device of claim 1, wherein
the first information is stored in a PHY header of the second signal.

5. The wireless communication device of claim 1, wherein
the circuitry is configured control notifying a first wireless communication device that is a destination of the first signal of a transmission method of a response signal to the first signal.

6. The wireless communication device of claim 5, wherein
the circuitry is configured to control notifying the transmission method when performing a capability check with another wireless communication device.

7. The wireless communication device of claim 5, wherein
the circuitry is configured to add information indicating the transmission method to an end of the first signal and control transmitting the first signal.

8. The wireless communication device of claim 5, wherein
the circuitry is configured to control reception of at least one of the response signal to the first signal from a first wireless communication device that is a destination of the first signal and the response signal to the second signal from a second wireless communication device that is a destination of the second signal according to the transmission method.

9. The wireless communication device of claim 1, wherein
the circuitry is configured to calculate a delay time for completing transmission of data from the first wireless communication device.

10. The wireless communication device of claim 9, wherein
the circuity is configured to determine to control transmission of the second signal including the data and control termination of transmission of the first signal in a case that the calculated delay time is less than a threshold value.

11. The wireless communication device of claim 1, wherein
the wireless communication device is an access point (AP) that operates in compliance with IEEE 802.11.

12. A wireless communication device comprising:
circuitry configured to control
receiving information indicating that transmission of a first signal by a transmission device is terminated in a case that transmission of the first signal is terminated by the transmission device and a second signal is transmitted by the transmission device; and
determining whether to transmit at least one of a first response signal to the first signal and a second response signal to the second signal according to a transmission method of the first response signal to the first signal.

13. The wireless communication device of claim 12, wherein the circuitry is configured to:
calculate a transmission timing of the first response signal in a case that the first signal is addressed to the own device; and
control transmission of the first response signal at the calculated transmission timing based on a length of the second signal.

14. The wireless communication device of claim 12, wherein
the transmission method is notified by the transmission device.

15. The wireless communication device of claim 14, wherein
the transmission method is notified when a capability check is performed with the transmission device.

16. The wireless communication device of claim 14, wherein
the transmission method is notified by information stored at an end of the first signal.

17. The wireless communication device of claim 12, wherein
the circuitry is configured to perform control to not transmit the first response signal, not stop demodulation, or not shift to a power saving state when the first signal is not addressed to the wireless communication device.

18. The wireless communication device of claim 17, wherein
the circuitry is configured to control transmission of the second response signal.

19. A communication method comprising:
transmitting a first signal;
determining, during transmission of the first signal, that a second signal is to be transmitted;
terminating transmission of the first signal;
transmitting a second signal after terminating transmission of the first signal, wherein
the second signal includes first information indicating that transmission of the first signal has been terminated.

20. A communication method comprising:
receiving information indicating that transmission of a first signal by a transmission device is terminated in a case that transmission of the first signal is terminated by the transmission device and a second signal is transmitted by the transmission device; and
determining whether to transmit at least one of a first response signal to the first signal and a second response signal to the second signal according to a transmission method of the first response signal to the first signal.
